(19) United States
(12) Patent Application Publication
(10) Pub. No.: US 2024/0332544 A1
(43) Pub. Date: Oct. 3, 2024

(54) POWER STORAGE DEVICE AND METHOD FOR PRODUCING THE SAME

(71) Applicant: Prime Planet Energy & Solutions, Inc., Tokyo (JP)

(72) Inventor: Yozo UCHIDA, Toyota-shi (JP)

(21) Appl. No.: 18/423,298

(22) Filed: Jan. 26, 2024

(30) Foreign Application Priority Data
Mar. 30, 2023 (JP) 2023-055401

(51) Int. Cl. H01M 4/70; H01M 10/04; H01M 50/103; H01M 50/119; H01M 50/553; H01M 50/566

(52) U.S. Cl. CPC H01M 4/70; H01M 50/119; H01M 50/566; H01M 10/0413; H01M 50/103; H01M 50/553; H01M 2220/20

(57) ABSTRACT

A power storage device includes a case having conductivity and an electrode body housed in the case. The electrode body includes a first current collecting portion and a second current collecting portion having a different polar from the first current collecting portion. The case and the first current collecting portion of the electrode body are conductively connected by a swaged joint portion where these are swaged and joined. The power storage device is provided with an electrode external terminal that is fixed to the case and insulated from the case. The electrode external terminal is connected to the second current collecting portion of the electrode body inside the case.

### CROSS-REFERENCE TO RELATED APPLICATIONS

This application is based upon and claims the benefit of priority from the prior Japanese Patent Application No. 2023-055401 filed on Mar. 30, 2023, the entire contents of which are incorporated herein by reference.

### BACKGROUND

### Technical Field

The present disclosure relates to a power storage device in which an electrode body is housed in a conductive case and a method for producing the power storage device.

### Related Art

There is known a battery in which an electrode body is housed in a conductive case. In a conventional battery, a positive external terminal and a negative external terminal are insulated from a case and fixed to the case to be respectively connected to a positive current collecting portion and a negative current collecting portion of the electrode body in the case. A related art is known as Japanese unexamined patent application publication No. 2022-44958 (see FIG. 1).

### SUMMARY

### Technical Problems

However, in the above-mentioned battery, the positive external terminal and the negative external terminal are insulated from the case, and that is why each of the positive external terminal and the negative external terminal requires an insulating member, which could result in increase in the number of components.

The present disclosure has been made in view of the above circumstances and has a purpose of providing a power storage device that can achieve reduction in the number of components as compared with a power storage device configured such that a positive external terminal and a negative external terminal are each insulated from a case.

### Means of Solving the Problems

(1) One aspect of the present disclosure to solve the above problem is to provide a power storage device comprising a case having conductivity and an electrode body housed in the case, wherein the electrode body includes a first current collecting portion and a second current collecting portion having an opposite polar from the first current collecting portion, the case and the first current collecting portion of the electrode body are conductively connected by a swaged joint portion in which the case and the first current collecting portion are swaged and joined, and the power storage device includes an electrode external terminal which is insulated from the case, fixed to the case, and connected to the second current collecting portion of the electrode body in the case.

In the above power storage device, the case is conducted with the first current collecting portion of the electrode body, and the case functions as one electrode external terminal, and thus no insulating member is required. Accordingly, as compared with a power storage device in which a positive external terminal and a negative external terminal are respectively insulated from the case, the number of components can be reduced. Further, the case and the first current collecting portion are conductively connected by the swaged joint portion, and thus the case and the first current collecting portion can be appropriately conductively connected.

As examples of a “power storage device”, there are exemplified secondary batteries such as a lithium-ion secondary battery, a sodium-ion secondary battery, and a calcium-ion secondary battery and capacitors such as a lithium-ion capacitor.

As examples of a “swaged joint portion”, there are exemplified a swaged joint portion, in which a metal member (for example, a metal plate, a metal ring, or the like) is overlapped on a first current collecting portion of an electrode body and the first current collecting portion is held between the case and the metal member to swage the case, the first current collecting portion, and the metal member, and another swaged joint portion, in which the first current collecting portion of the electrode body is welded to the metal member (for example, a metal plate, or the like) and the metal member is overlapped on the case to swage the case, the metal member, and the first current collecting portion.

(2) Further, the power storage device in the above (1), preferably, the case is formed of a metal plate, and the swaged joint portion is formed by recessing the case to an inner side in a plate thickness direction.

In the above power storage device, the swaged joint portion between the case and the first current collecting portion of the electrode body is formed by recessing the case to the inner side so that the swaged joint portion does not protrude outside of the case. Accordingly, formation of the swaged joint portion does not obstruct flexibility in placement and others of the power storage device.

(3) Further, in the power storage device in the above (1) or (2), preferably, a case joint portion of the case forming the swaged joint portion and a current collecting joint portion of the first current collecting portion of the electrode body forming the swaged joint portion are welded.

In the above power storage device, the case joint portion constituting the swaged joint portion of the case and the current collecting joint portion constituting the swaged joint portion of the first current collecting portion of the electrode body are not only swaged and joined but also welded, and thus the case and the first current collecting portion can be assuredly conductively connected with especially low resistance.

(4) Another aspect of the present disclosure is to provide a method for producing a power storage device comprising a case having conductivity and an electrode body housed in the case, the electrode body including a first current collecting portion and a second current collecting portion having an opposite polar from the first current collecting portion, the case and the first current collecting portion of the electrode body being conductively connected by a swaged joint portion in which the case and the first current collecting portion are swaged and joined, the power storage device including an electrode external terminal which is insulated from the case, fixed to the case, and connected to the second current collecting portion of the electrode body in the case, wherein the method includes swaging to swage and join the case and the first current collecting portion of the electrode body for forming the swaged joint portion.

In joining the case and the first current collecting portion of the electrode body, for example, when the laser beam is irradiated to the first current collecting portion of the electrode body to weld the first current collecting portion of the electrode body to the case, there is generated metal foreign matters arising from spatters in the case. These metal foreign matters could cause internal short circuit. On the contrary, in the above-mentioned method for producing the power storage device, swaging and joining are performed in the step of the swaging, so that the case and the first current collecting portion of the electrode body are conductively connected, thereby preventing the above-mentioned internal short circuit due to the metal foreign matters. This results in appropriate joining of the case and the first current collecting portion of the electrode body.

(5) Further, in the method for producing the power storage device according to the above (4), preferably, the case is formed of a metal plate, the first current collecting portion of the electrode body is formed by laminating a first current collecting foil in a foil thickness direction, the swaging is performed by: utilizing a die having a recessed portion and a punch having a leading end portion; overlapping the case and the first current collecting portion to coincide a plate thickness direction and the foil thickness direction of the case and positioning the case on a side of the punch and the first current collecting portion on a side of the die to place the case and the first current collecting portion between the leading end portion of the punch and the recessed portion of the die; and moving the leading end portion of the punch to the recessed portion of the die to swage and join the case and the first current collecting portion.

In the above method for producing the power storage device, the step of the swaging is performed by use of the die and the punch as mentioned above so that the swaged joint portion between the case and the first current collecting portion of the electrode body is formed by recessing the case to the inner side. Accordingly, formation of the swaged joint portion does not obstruct flexibility in placement and others of the power storage device.

(6) Further, the method for producing the power storage device in the above (4) or (5), preferably, further includes swaged-portion welding to weld a case joint portion of the case forming the swaged joint portion and a current collecting joint portion of the first current collecting portion of the electrode body forming the swaged joint portion.

In the above method for producing the power storage device, the case joint portion of the case constituting the swaged joint portion and the current collecting joint portion of the first current collecting portion of the electrode body constituting the swaged joint portion are not only swaged and joined in the step of the swaging but also welded in the step of the swaged-portion welding, and thus the case and the first current collecting portion can be assuredly conductively connected with especially low resistance.

(7) Further, in the method for producing the power storage device in the above (6), preferably, the swaged-portion welding is performed by irradiating a laser beam to the case joint portion from outside of the case and laser-welding the case joint portion to the current collecting joint portion.

In the above method for producing the power storage device, the laser beam is irradiated to the case joint portion from outside of the case to laser weld the case joint portion with the current collecting joint portion of the first current collecting portion, thereby preventing generation of the metal foreign matters arising from the spatters in the case.

### BRIEF DESCRIPTION OF THE DRAWINGS

FIG. 1 is a perspective view of a battery in an embodiment;

FIG. 2 is a partially broken sectional view along a case height direction and a case width direction of the battery in the embodiment;

FIG. 3 is a sectional view of the battery in the case height direction and the case thickness direction in the embodiment, taken along an arrow in FIGS. 1 and 2;

FIG. 4 is a partially enlarged sectional view of a vicinity of a swaged joint portion of the battery in the embodiment shown in FIG. 3;

FIG. 5 is a sectional view of the battery in the case height direction and the case thickness direction in the embodiment, taken along another arrow in FIGS. 1 and 2;

FIG. 6 is a flow chart of a method for producing the battery in the embodiment;

FIG. 7 is an explanatory view illustrating a state in which a negative current collecting portion of an electrode body is laser welded to a negative external terminal fixed to a case body member in a terminal connecting step for producing the battery in the embodiment;

FIG. 8 is an explanatory view illustrating a state in which the electrode body is housed in the case body member for producing the battery in the embodiment;

FIG. 9 is an explanatory view illustrating a state in which a punch and a die are disposed in a swaging step for producing the battery in the embodiment;

FIG. 10 is an explanatory view illustrating a state in which the case, a positive current collecting portion of the electrode body, and a metal plate are swaged and joined by the punch and the die in the swaging step for producing the battery in the embodiment; and

FIG. 11 is an explanatory view illustrating a state in which a case joint portion, a current collecting joint portion, and a metal plate joint portion which form a swaged joint portion are laser welded in a swaged-portion welding step for producing the battery in the embodiment.

### DETAILED DESCRIPTION OF THE EXEMPLARY EMBODIMENTS

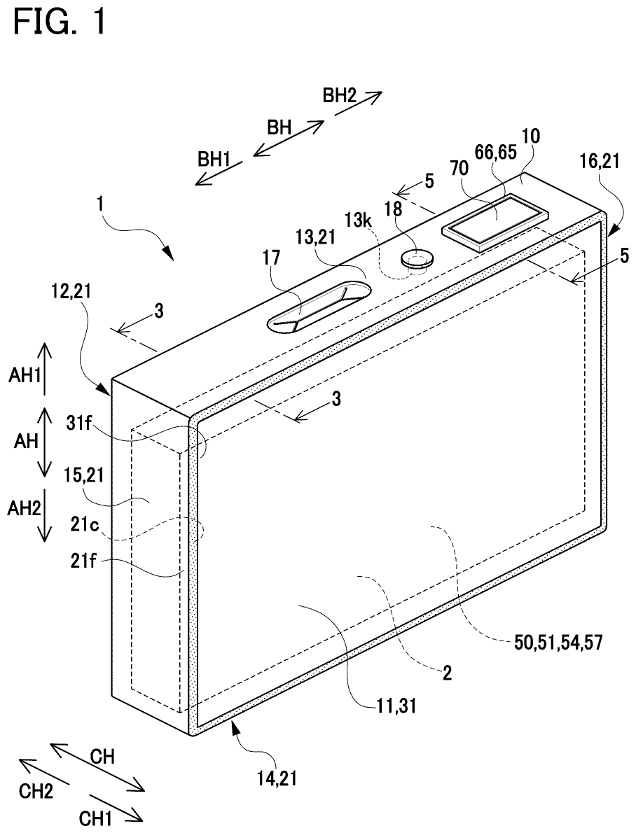

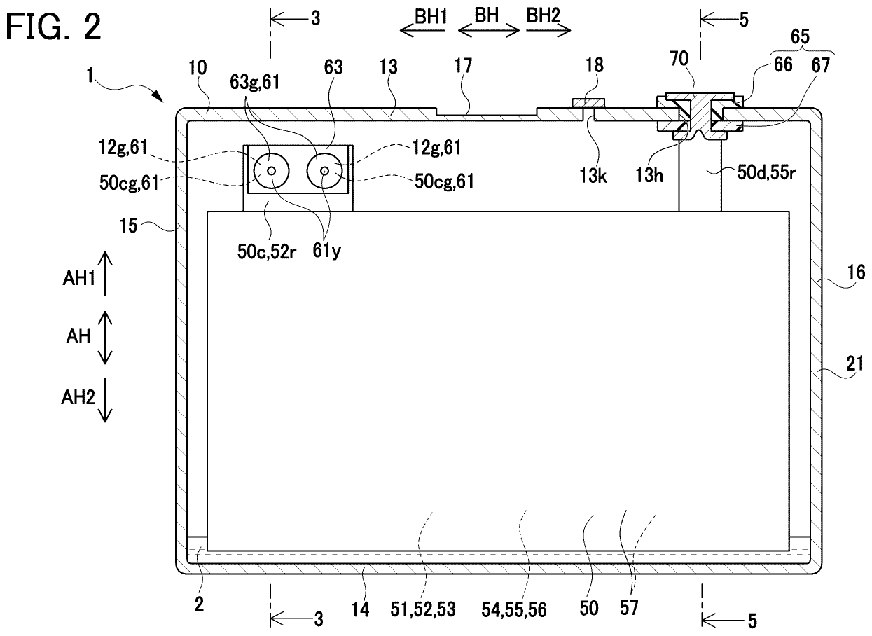

An embodiment of the present disclosure is now explained below with reference to the accompanying drawings. FIG. 1 is a perspective view of a battery 1 (i.e., a power storage device of the present disclosure) according to the present embodiment, and FIGS. 2 to 5 are sectional views of the battery 1. In the following explanation, a case height direction AH, a case width direction BH, and a case thickness direction CH of the battery 1 are defined as directions indicated in FIGS. 1 to 5. The battery 1 is a rectangular, more specifically, rectangular parallelepiped sealed lithium-ion secondary battery which will be installed in vehicles such as a hybrid vehicle, a plug-in hybrid vehicle, and an electric automobile.

The battery 1 is configured with a case 10 at the positive potential, a laminated-type electrode body 50 housed in the case 10, a negative external terminal 70 (an electrode external terminal) insulated from and supported by the case 10, and others. The electrode body 50 is covered with a not-shown bag-shaped insulating holder formed of an insulating film in the case 10. The case 10 further contains an electrolytic solution 2, a part of which is impregnated in the electrode body 50 and the remainder of which is accumulated on a second side wall portion 14 as a bottom wall portion of the case 10.

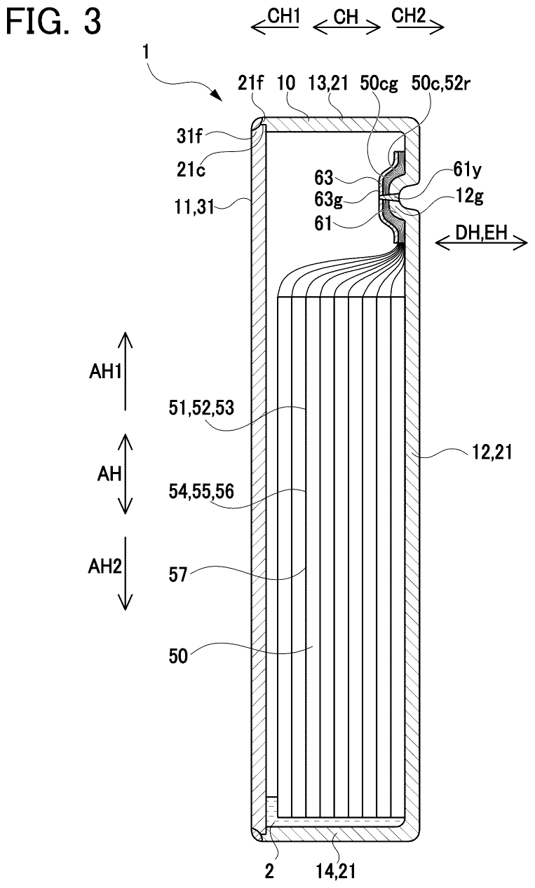

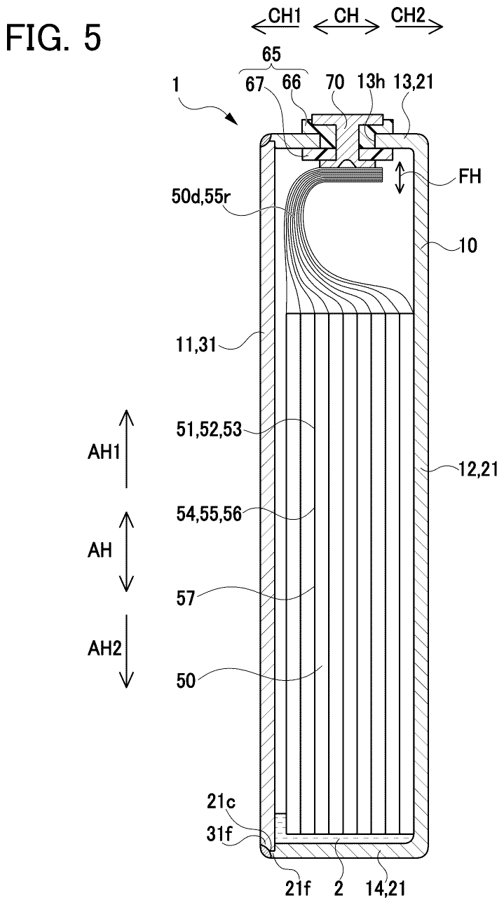

The case 10 is formed of a metal plate, specifically, an aluminum plate in the present embodiment, and has conductivity. The case 10 has a parallelepiped box-like shape and includes a first primary wall portion 11, a second primary wall portion 12, and four side wall portions 13 to 16 (specifically, a first side wall portion 13, a second side wall portion 14, a third side wall portion 15, and a fourth side wall portion 16), each of which is of a rectangular plate-like shape. The first primary wall portion 11 and the second primary wall portion 12 have wider area than the side wall portions 13 to 16. The first primary wall portion 11 and the second primary wall portion 12 oppose to each other. The first primary wall portion 11 is positioned on one side CH1 (specifically, a right forward side in FIG. 1 and a left side in FIGS. 3 and 5) of the case thickness direction CH, and the second primary wall portion 12 is positioned on the other side CH2 (specifically, a left rear side in FIG. 1 and a right side in FIGS. 3 and 5) of the case thickness direction CH.

On the other hand, the side wall portions 13 to 16 each join the first primary wall portion 11 and the second primary wall portion 12 and extend in the case thickness direction CH. The first side wall portion 13 and the second side wall portion 14 oppose to each other in a manner that the first side wall portion 13 is positioned on an upper side AH1 in the case height direction AH and the second side wall portion 14 is positioned on a lower side AH2 in the case height direction AH. Further, the third side wall portion 15 and the fourth side wall portion 16 oppose to each other in a manner that the third side wall portion 15 is positioned on one side BH1 in the case width direction BH and the fourth side wall portion 16 is positioned on the other side BH2 in the case width direction BH.

This case 10 is configured with a case body member 21 and a lid 31. The case body member 21 is of a bottomed rectangular cylindrical shape provided with a rectangular opening 21c and houses with the electrode body 50. The lid 31 is of a rectangular plate-like shape and closes the opening 21c of the case body member 21. Among these components, the case body member 21 constitutes the above-mentioned second primary wall portion 12 and the four side wall portions 13 to 16. The lid 31 constitutes the above-mentioned first primary wall portion 11, and a lid peripheral edge portion 31f of the lid 31 and an opening peripheral edge portion 21f the opening 21c of the case body member 21 are hermetically joined (to be specific, welded in the present embodiment) over an entire circumference.

A safety valve 17 is provided in the first side wall portion 13 as an upper wall portion of the case 10 and will break and open when an internal pressure of the case 10 exceeds a valve opening pressure. Further, a liquid inlet 13k is provided to penetrate through the first side wall portion 13 and to be hermetically sealed by a disc-shaped sealing member 18 made of aluminum.

Further, in the first side wall portion 13, a negative external terminal 70 made of copper is fixed to a vicinity of an end portion on the other side BH2 in the case width direction BH. Specifically, in the first side wall portion 13, an insertion hole 13h penetrating through the first side wall portion 13 is provided in the vicinity of the end portion on the other side BH2 in the case width direction BH, and the negative external terminal 70 is inserted into this insertion hole 13h to extend from an inside to the outside of the case 10. The negative external terminal 70 is conductively connected in the case 10 with the negative current collecting portion 50d of the electrode body 50 which will be explained below. Further, the negative external terminal 70 and the first side wall portion 13 are insulated from each other via an insulating portion 65. This insulating portion 65 is formed of an external resin member 66, which is positioned outside the first side wall portion 13 and inside the insertion hole 13h, and an internal resin member 67 which is positioned inside the first side wall portion (namely, in the case 10), both of which are respectively made of insulating resin.

Next, the electrode body 50 is explained. This electrode body 50 is a rectangular parallelepiped laminated-type and is formed in such a manner that a plurality of positive electrode plates 51 (one example of a first electrode plate) and a plurality of negative electrode plates 54 (one example of a second electrode plate) are laminated alternately with separators 57 formed of resin-made porous films sandwiched therebetween in the case thickness direction CH. The positive electrode plates 51, the negative electrode plates 54, and the separators 57 are each of a rectangular shape extending in the case height direction AH and the case width direction BH.

The positive electrode plate 51 is formed of a positive current collecting foil 52 (one example of a first current collecting foil) formed of an aluminum foil and positive active material layers 53 (one example of a first active material layer) which are formed on both primary surfaces of the positive current collecting foil 52. The positive active material layers 53 include positive active material particles which can occlude and discharge lithium ions. Further, a part of the positive current collecting foil 52 extends to the upper side AH1 in the vicinity of the end portion on the one side BH1 in the case width direction BH, and both surfaces of the positive current collecting foil 52 include no positive active material layers 53, so that the positive current collecting foil 52 is exposed to become positive electrode foil exposed portions 52r (one example of a first foil exposed portion). Each of the positive electrode foil exposed portions 52r of the positive electrode plate 51 is overlapped in a foil thickness direction EH to form the positive current collecting portion 50c (one example of the first current collecting portion). This positive current collecting portion 50c is conductively connected to the case 10 by swaging and joining as explained below.

The negative electrode plate 54 is formed of a negative current collecting foil 55 (one example of a second current collecting foil) formed of a copper foil and negative active material layers (one example of a second active material layer) which are formed on both primary surfaces of the negative current collecting foil 55. The negative active material layers 56 include negative active material particles that can occlude and discharge the lithium ions. Further, a part of the negative current collecting foil 55 extends to the upper side AH1 in the vicinity of the end portion on the other side BH2 in the case width direction BH, and both surfaces of the negative current collecting foil 55 include no negative active material layers 56, so that the negative current collecting foil 55 is exposed to become negative electrode foil exposed portions 55r (one example of a second foil exposed portion). Each of the negative electrode foil exposed portions 55r of the negative electrode plate 54 is overlapped in a foil thickness direction FH to form the negative current collecting portion 50d (one example of the second current collecting portion). This negative current collecting portion 50d is conductively connected to the negative external terminal 70.

The positive current collecting portion 50c of the electrode body 50 and the second primary wall portion 12 of the case 10 are conductively connected at the two swaged joint portions 61 where the positive current collecting portion 50c and the second primary wall portion 12 are swaged and joined. These swaged joint portions 61 are formed in the vicinity of the end portion on the upper side AH1 in the case height direction AH and on the one side BH1 in the case width direction BH in the second primary wall portion 12.

In the present embodiment, the swaged joint portion 61 is formed in such a manner that a metal plate 63 (one example of a metal member) formed of a rectangular aluminum plate is overlapped on the positive current collecting portion 50c to hold the positive current collecting portion 50c between the second primary wall portion 12 and the metal plate 63 and to swage the second primary wall portion 12, the positive current collecting portion 50c, and the metal plate 63 together. Not only the second primary wall portion 12 and the positive current collecting portion 50c are overlapped and swaged but the positive current collecting portion 50c is held between the second primary wall portion 12 and the metal plate 63 and they are swaged altogether, thus swaging and joining can be assuredly performed.

The swaged joint portion 61 is configured such that the case 10 is recessed to the inner side DH1 in the plate thickness direction DH. Specifically, of the second primary wall portion 12 in the case 10, a case joint portion 12g constituting the swaged joint portion 61 is recessed inwardly in the case 10 to be of a circular shape in planar view on the inner side DH1 in the plate thickness direction DH. Further, in the positive current collecting portion 50c of the electrode body 50, a current collecting joint portion 50cg constituting the swaged joint portion 61 is also recessed inwardly in the case 10 to be of a circular shape in planar view in the foil thickness direction EH. Further, in the metal plate 63, a metal plate joint portion 63g constituting the swaged joint portion 61 is also recessed inwardly in the case 10 to be of a circular shape in planar view. Furthermore, the swaged joint portion 61 has a welded portion 61y formed by welding the case joint portion 12g, the current collecting joint portion 50cg, and the metal plate joint portion 63g in its center.

As explained above, the battery 1 is configured such that the case 10 is conducted with the positive current collecting portion 50c of the electrode body 50 and the case 10 functions as a positive external terminal, thereby requiring no insulating member. Accordingly, the number of components can be reduced as compared to a battery in which a positive external terminal and a negative external terminal are each insulated from a case. Further, the case 10 and the positive current collecting portion 50c of the electrode body 50 are conductively connected by the swaged joint portion 61, and thus the case 10 and the positive current collecting portion 50c can be conductively connected in an appropriate manner.

Further in the present embodiment, the swaged joint portion 61 is formed by recessing the case 10 to the inner side DH1, and thus the swaged joint portion 61 does not protrude to the outer side DH2 of the case 10. Accordingly, formation of the swaged joint portion 61 does not obstruct flexibility in placement and others of the battery 1.

Further, the case joint portion 12g of the case 10 constituting the swaged joint portion 61 and the current collecting joint portion 50cg of the positive current collecting portion 50c of the electrode body 50 constituting the swaged joint portion 61 are not only swaged and joined but also welded, namely, the welded portion 61y is formed in the swaged joint portion 61, and thus the case 10 and the positive current collecting portion 50c can be assuredly conductively connected at especially low resistance.

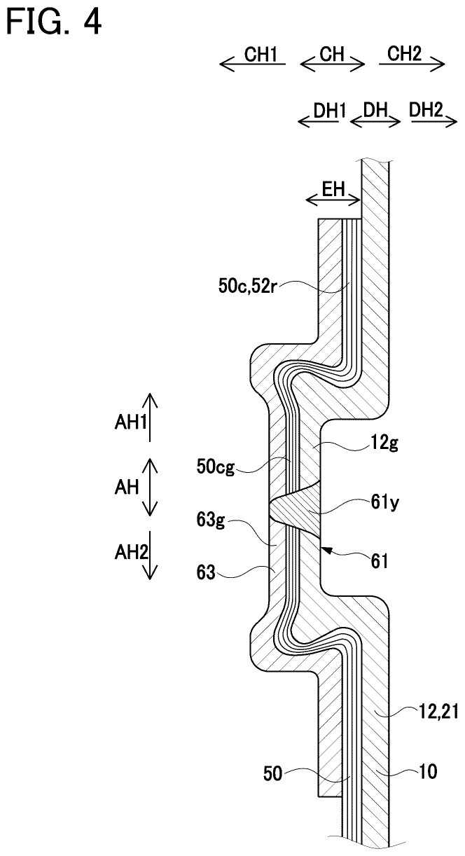

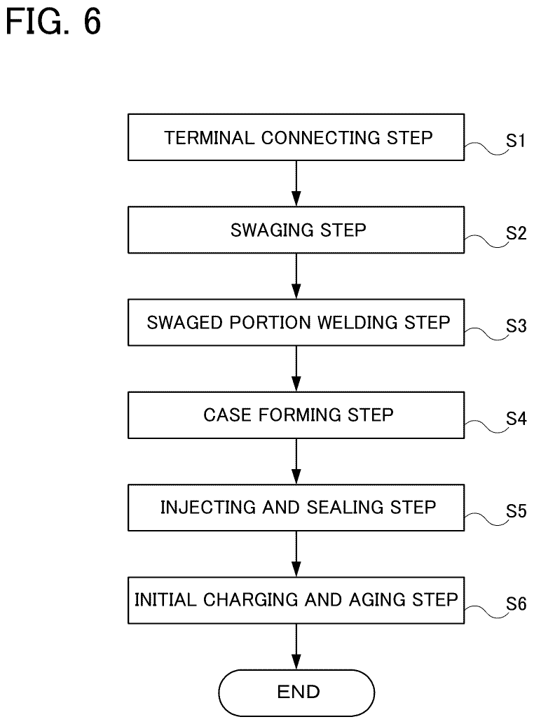

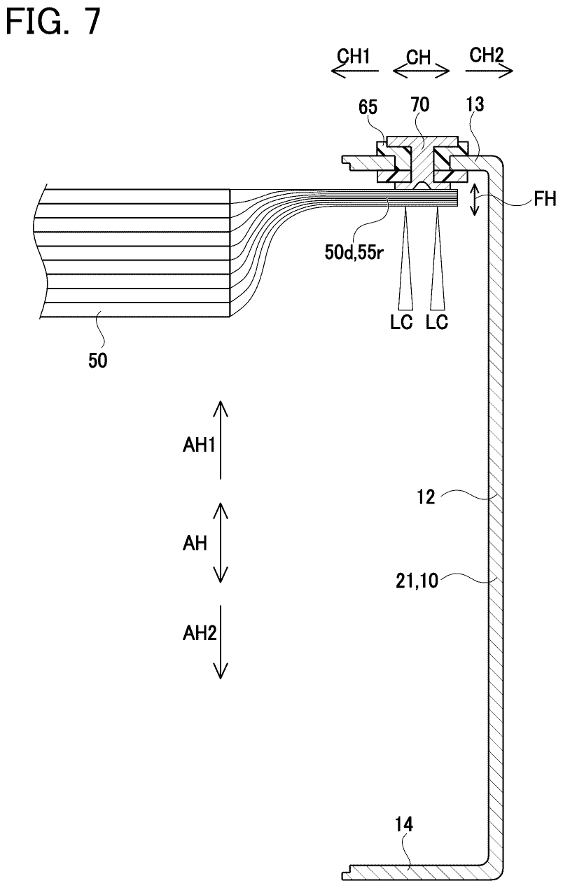

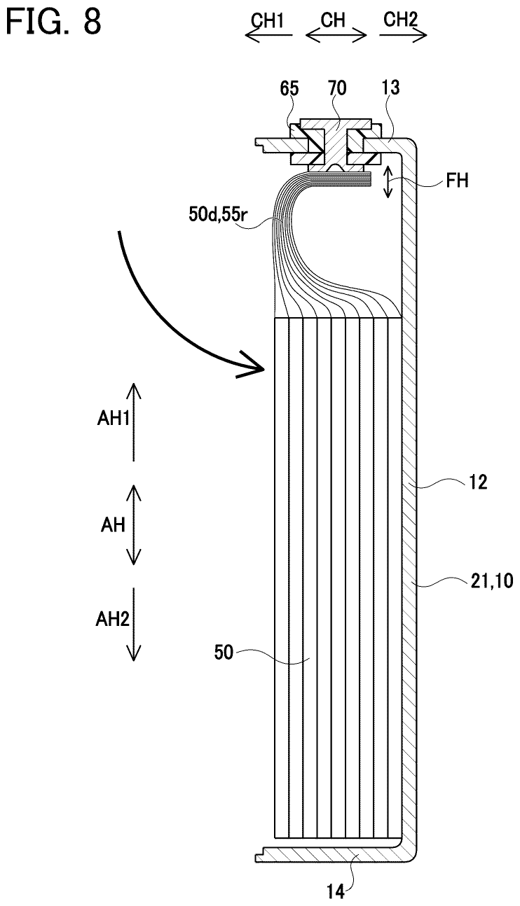

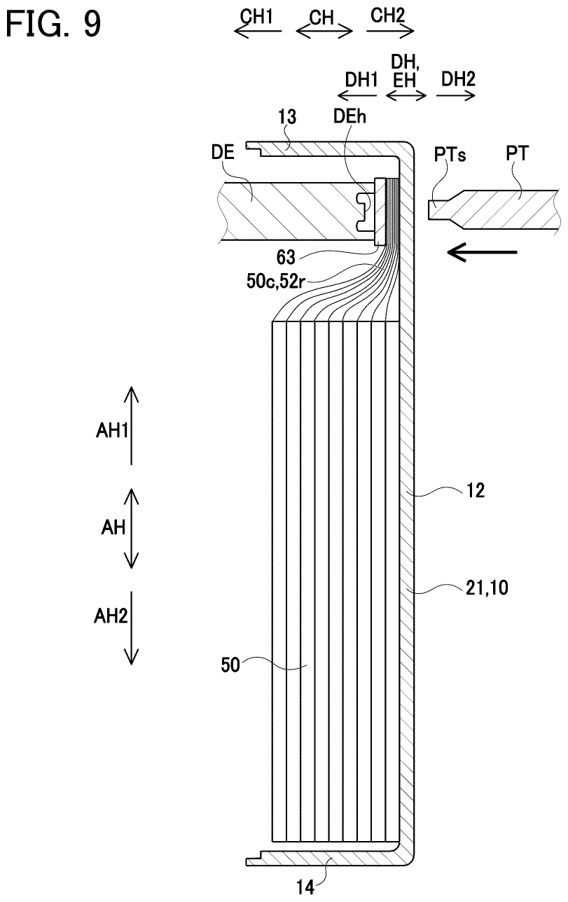

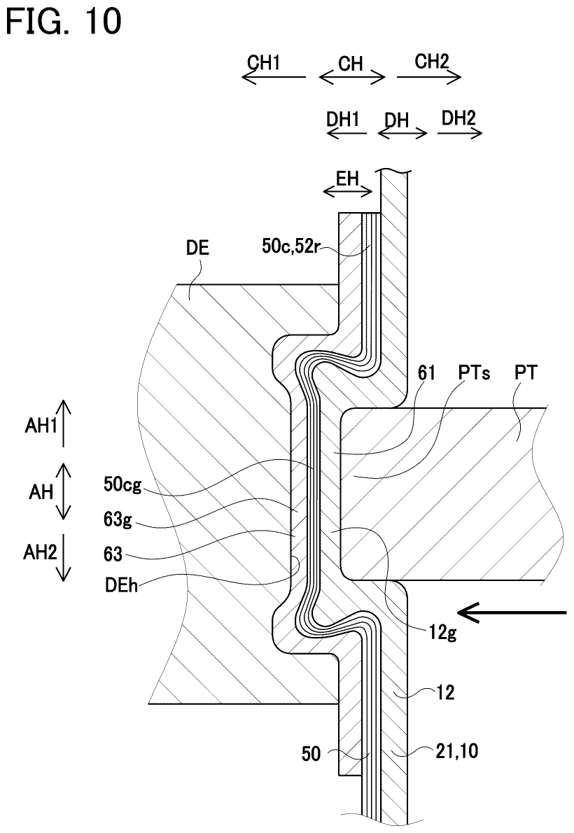

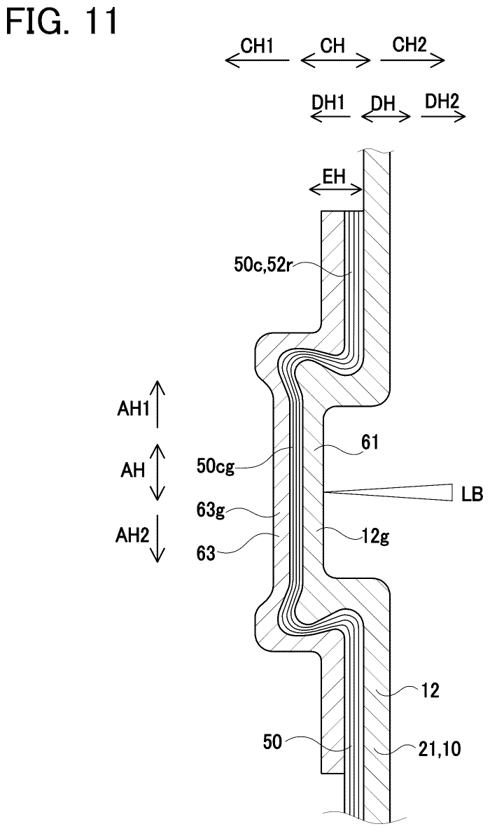

Next, a method for producing the battery 1 is explained (see FIGS. 6 to 11). Herein, FIGS. 7 and 8 are explanatory sectional views corresponding to FIG. 5. FIG. 9 is an explanatory sectional view corresponding to FIG. 3. FIGS. 10 and 11 are explanatory sectional views corresponding to FIG. 4.

Firstly, the case body member 21 is prepared and the negative external terminal 70 is fixed to the first side wall portion 13 of the case body member 21. Then, the positive electrode plates 51, the negative electrode plates 54, and the separators 57 are laminated to form the electrode body 50 including the positive current collecting portion 50c and the negative current collecting portion 50d. The electrode body 50 is wrapped in advance with a bag-shaped insulating holder (not-shown).

In a “terminal connecting step S1” (see FIG. 6), the negative external terminal 70 fixed to the case body member 21 is connected with the negative current collecting portion 50d of the electrode body 50 (see FIG. 7). Specifically, the negative current collecting portion 50d of the electrode body 50 is brought into contact with the negative external terminal 70 from the lower side AH2 to the upper side AH1 in the case height direction AH, and then a laser beam LC is irradiated to the negative current collecting portion 50d from the lower side AH2 to the upper side AH1 to laser weld the negative current collecting portion 50d to the negative external terminal 70. Thereafter, the electrode body 50 is bent at the negative current collecting portion 50d so that the electrode body 50 is housed in the case body member 21 (see FIG. 8).

Subsequently, in a “swaging step S2” (see FIG. 6), the second primary wall portion 12 of the case 10, the positive current collecting portion 50c of the electrode body 50, and a metal plate 63 are swaged and joined to form the swaged joint portion 61 (see FIGS. 9 and 10). This swaging step S2 is performed by use of a die DE having a recessed portion DEh of a circular shape in planar view and a punch PT having a leading end portion PTs of a cylindrical columnar shape with an outer diameter smaller than the inner diameter of the recessed portion DEh of the die DE.

Firstly, the second primary wall portion 12 of the case 10, the positive current collecting portion 50c of the electrode body 50, and the metal plate 63 are placed between the leading end portion PTs of the punch PT and the recessed portion DEh of the die DE (see FIG. 9). To be specific, the second primary wall portion 12 of the case 10, the positive current collecting portion 50c of the electrode body 50, and the metal plate 63 are overlapped in such a manner that the plate thickness direction DH of the second primary wall portion 12 and the foil thickness direction EH of the positive current collecting foil 52 coincide, so that the second primary wall portion 12 of the case 10 is placed on a side of the punch PT and the metal plate 63 and the positive current collecting portion 50c are placed on a side of the die DE.

Thereafter, the leading end portion PTs of the punch PT is brought toward the recessed portion DEh of the die DE to swage and join the second primary wall portion 12 of the case 10, the positive current collecting portion 50c, and the metal plate 63 by the leading end portion PTs of the punch PT and the recessed portion DEh of the die DE (see FIG. 10). Thus, the swaged joint portion 61, which is formed of the case joint portion 12g of the second primary wall portion 12, the current collecting joint portion 50cg of the positive current collecting portion 50c, and the metal plate joint portion 63g of the metal plate 63, is formed.

Then, the punch PT and the die DE are displaced in the case width direction BH to similarly perform swaging and joining, so that another swaged joint portion 61 is formed. In this manner, the second primary wall portion 12 of the case 10 and the positive current collecting portion 50c of the electrode body 50 are conductively connected by the two swaged joint portions 61.

Subsequently, in a “swaged-portion welding step S3” (see FIG. 6), the case joint portion 12g of the second primary wall portion 12 of the case 10 constituting the swaged joint portion 61, the current collecting joint portion 50cg of the positive current collecting portion 50c of the electrode body 50 constituting the swaged joint portion 61, and the metal plate joint portion 63g of the metal plate 63 constituting the swaged joint portion 61 are welded (see FIG. 11). Specifically, each of the two swaged joint portions 61 is irradiated with the laser beam LB from the outside of the case 10 (specifically, from the outer side DH2 to the inner side DH1 in the plate thickness direction DH) toward a center portion of the case joint portion 12g of the second primary wall portion 12 to laser weld the center portion of the case joint portion 12g, the center portion of the current collecting joint portion 50cg of the positive current collecting portion 50c, and the center portion of the metal plate joint portion 63g of the metal plate 63. Thus, the welded portion 61y is formed in a center of the respective swaged joint portions 61 (see FIG. 4).

Subsequently, in a “case forming step S4” (see FIG. 6), the lid 31 is joined to the case body member 21 to form the case 10. Specifically, the lid 31 is put on the case body member 21 and the lid peripheral edge portion 31f of the lid 31 is brought into contact with the opening peripheral edge portion 21f of the case body member 21 over an entire circumference. Thereafter, the lid peripheral edge portion 31f and the opening peripheral edge portion 21f are hermetically laser welded over the entire circumference to form the case 10.

Subsequently, in an “injecting and sealing step S5”, the electrolytic solution 2 is injected into the case 10 through the liquid inlet 13k to impregnate the electrolytic solution 2 in the electrode body 50. Thereafter, the liquid inlet 13k is covered by the sealing member 18 from outside and the sealing member 18 is hermetically laser welded to the case 10.

Subsequently, in an “initial charging and aging step S6”, the battery 1 is connected to a charging device (not shown) to initially charge the battery 1. Thereafter, the thus initially charged battery 1 is left stand for a predetermined time for aging. Thus, the battery 1 is completed.

In joining the case 10 and the positive current collecting portion 50c of the electrode body 50, for example, there is a case that metal foreign matters are generated due to spatters in the case 10 when the laser beam is irradiated to the positive current collecting portion 50c of the electrode body 50 to laser weld the positive current collecting portion 50c of the electrode body 50 to the case 10. The thus generated metal foreign matters could cause internal short circuit. To address this, in the present method for producing the battery 1, swaging and joining is performed in the swaging step S2 to conductively connect the case 10 and the positive current collecting portion 50c of the electrode body 50, so that the metal foreign matters are not generated and the internal short circuit would not happen as above. Accordingly, the case 10 and the positive current collecting portion 50c of the electrode body 50 can be joined in an appropriate manner.

Further in the present embodiment, the swaging step S2 is performed by use of the punch PT and the die DE as mentioned above, and thus the swaged joint portion 61 is configured such that the second primary wall portion 12 of the case 10 is recessed to the inner side DH1. Accordingly, formation of the swaged joint portion 61 would not obstruct flexibility in placement and others of the battery 1.

Further in the present embodiment, the case joint portion 12g of the second primary wall portion 12 of the case 10 constituting the swaged joint portion 61 and the current collecting joint portion 50cg of the positive current collecting portion 50c of the electrode body 50 constituting the swaged joint portion 61 are swaged and joined in the swaging step S2, and they are further welded in the swaged-portion welding step S3, so that the second primary wall portion 12 of the case 10 and the positive current collecting portion 50c can be assuredly conductively connected at particularly low resistance.

Further in the swaged-portion welding step S3, the laser beam LB is irradiated from the outside of the case 10 toward the case joint portion 12g to laser weld the case joint portion 12g to the current collecting joint portion 50cg of the positive current collecting portion 50c, which makes it possible by this welding to prevent generation of the metal foreign matters arising from the spatters in the case 10.

The present disclosure has been explained as above along with the embodiment, but the present disclosure is not limited to the embodiment and may be modified in an appropriate manner without departing from the scope of the disclosure.

For example, in the present embodiment, the swaged joint portion 61 is provided in the second primary wall portion 12 of the case 10, but arrangement is not limited to this. The swaged joint portion 61 may be provided in other portions of the case 10 such as the first primary wall portion 11 and the first side wall portion 13.

Further, the present embodiment illustrates the battery 1 in which the case 10 is at the positive potential, but alternatively, the battery may be configured with the case 10 at the negative potential. Namely, the case 10 and the negative current collecting portion of the electrode body are conductively connected by the swaged joint portion in which the case and the negative current collecting portion are swaged and joined. Further, a positive external terminal is fixed to but insulated from the case 10 so that a positive current collecting portion of the electrode body is conductively connected to a positive external terminal in the case 10.

### REFERENCE SIGNS LIST

1 Battery (Power storage device)
10 Case
12g Case joint portion
50 Electrode body
50c Positive current collecting portion (First current collecting portion)
50cg Current collecting joint portion
50d Negative current collecting portion (Second current collecting portion)
51 Positive electrode plate (First electrode plate)
52 Positive current collecting foil (First current collecting foil)
52r Positive electrode foil exposed portion (First foil exposed portion)
54 Negative electrode plate (Second electrode plate)
55 Negative current collecting foil (Second current collecting foil)
55r Negative electrode foil exposed portion (Second foil exposed portion)
61 Swaged joint portion
61y Welded portion
65 Insulating portion
66 External resin member
67 Internal resin member
70 Negative external terminal (Electrode external terminal)
DH Plate thickness direction (of the case)
DH1 Inner side (of the plate thickness direction)
DH2 Outer side (of the plate thickness direction)
EH Foil thickness direction (of the positive current collecting foil)
LB,LC Laser beam
DE Die
DEh Recessed portion (of the die)
PT Punch
PTs Leading end portion (of the punch)
S2 Swaging step
S3 Swaged-portion welding step

What is claimed is:

1. A power storage device comprising a case having conductivity and an electrode body housed in the case, wherein
the electrode body includes a first current collecting portion and a second current collecting portion having an opposite polar from the first current collecting portion,
the case and the first current collecting portion of the electrode body are conductively connected by a swaged joint portion in which the case and the first current collecting portion are swaged and joined, and
the power storage device includes an electrode external terminal which is insulated from the case, fixed to the case, and connected to the second current collecting portion of the electrode body in the case.

2. The power storage device according to claim 1, wherein
the case is formed of a metal plate, and
the swaged joint portion is formed by recessing the case to an inner side in a plate thickness direction.

3. The power storage device according to claim 1, wherein a case joint portion of the case forming the swaged joint portion and a current collecting joint portion of the first current collecting portion of the electrode body forming the swaged joint portion are welded.

4. A method for producing a power storage device comprising a case having conductivity and an electrode body housed in the case,
the electrode body including a first current collecting portion and a second current collecting portion having an opposite polar from the first current collecting portion,
the case and the first current collecting portion of the electrode body being conductively connected by a swaged joint portion in which the case and the first current collecting portion are swaged and joined,
the power storage device including an electrode external terminal which is insulated from the case, fixed to the case, and connected to the second current collecting portion of the electrode body in the case,
wherein the method includes swaging to swage and join the case and the first current collecting portion of the electrode body for forming the swaged joint portion.

5. The method for producing the power storage device according to claim 4, wherein
the case is formed of a metal plate,
the first current collecting portion of the electrode body is formed by laminating a first current collecting foil in a foil thickness direction,
the swaging is performed by:
utilizing a die having a recessed portion and a punch having a leading end portion;
overlapping the case and the first current collecting portion to coincide a plate thickness direction and the foil thickness direction of the case and positioning the case on a side of the punch and the first current collecting portion on a side of the die to place the case and the first current collecting portion between the leading end portion of the punch and the recessed portion of the die; and
moving the leading end portion of the punch to the recessed portion of the die to swage and join the case and the first current collecting portion.

6. The method for producing the power storage device according to claim 4 further includes swaged-portion welding to weld a case joint portion of the case forming the swaged joint portion and a current collecting joint portion of the first current collecting portion of the electrode body forming the swaged joint portion.

7. The method for producing the power storage device according to claim 6, wherein the swaged-portion welding is performed by irradiating a laser beam to the case joint portion from outside of the case and laser-welding the case joint portion to the current collecting joint portion.

8. The power storage device according to claim 2, wherein a case joint portion of the case forming the swaged joint portion and a current collecting joint portion of the first current collecting portion of the electrode body forming the swaged joint portion are welded.

9. The method for producing the power storage device according to claim 5 further includes swaged-portion welding to weld a case joint portion of the case forming the swaged joint portion and a current collecting joint portion of the first current collecting portion of the electrode body forming the swaged joint portion.

10. The method for producing the power storage device according to claim 9, wherein the swaged-portion welding is performed by irradiating a laser beam to the case joint portion from outside of the case and laser-welding the case joint portion to the current collecting joint portion.
